(19) United States
(12) Patent Application Publication
(10) Pub. No.: US 2014/0026538 A1
(43) Pub. Date: Jan. 30, 2014

(54) TURBO CHARGER PRE-SPOOLER

(71) Applicants: John Hauser, Wayne, PA (US); Andrew Ross, Clifton Heights, PA (US)

(72) Inventors: John Hauser, Wayne, PA (US); Andrew Ross, Clifton Heights, PA (US)

(73) Assignee: JATechnologies, LLC, Wayne, PA (US)

(21) Appl. No.: 13/557,875

(22) Filed: Jul. 25, 2012

(51) Int. Cl. F02D 23/00; B23P 15/00; F02B 33/44

(52) U.S. Cl. 60/273; 60/605.1; 29/888.025

(57) ABSTRACT

A turbo charger for an internal combustion engine includes a turbo charger housing defining a spool axis and including an exhaust chamber having an exhaust inlet and an exhaust outlet. The turbo charger housing also defines an air compressor chamber having an air inlet and an air outlet. A spool is mounted within the turbo charger housing for rotation about the spool axis. The spool includes a spool shaft with an exhaust turbine wheel mounted at one end and an air compressor wheel coaxially mounted for common rotation at the opposite end of the spool shaft. A compressed gas injector is mounted to the exhaust chamber of the turbo charger housing for providing a compressed gas flow to the exhaust turbine wheel from a source external to the turbo charger housing in order to supplement power from the exhaust to rotate the spool.

### BACKGROUND OF THE INVENTION

1. Field of the Invention

The present invention relates to internal combustion engines, and more particularly to turbo chargers for forced induction in internal combustion engines.

2. Description of Related Art

Natural aspiration of internal combustion engines is often augmented with forced induction by means of superchargers and turbo chargers. Superchargers are directly driven by belts, chains, or the like, taking power directly off the engine to compress air for forced induction. A proper supercharger provides a net increase in engine power by providing a greater increase in horse power than is required to drive the supercharger itself.

Turbo chargers yield a higher efficiency than superchargers because they convert energy in the exhaust gas stream from the engine into power to compress the air for forced induction. Therefore, they add horsepower to the engine without having to take any power from the engine for their own operation. One drawback of turbo chargers is that they are dependent on the flow of exhaust gases from the engine, which are not always available in adequate amounts. One particular problem this causes is known as turbo lag, which is a lag in turbo charger output after a rapid increase in engine speed.

For example, when a turbo charged engine is rapidly accelerated from idle to full power, such as when starting a car or truck from a dead stop, the low exhaust flow at idle speeds does not initially provide much turbo boost for forced induction, and not until the engine has accelerated to a sufficient level to produce adequate exhaust flow does the turbo charger fully boost the engine's horse power. Thus the full benefits of the turbo charger are not available at the beginning of an acceleration.

Various approaches have been taken to mitigate turbo lag. For example, U.S. Pat. No. 2,921,431 to Sampietro discloses a system with a combustion chamber attached to the turbo charger so that exhaust from the combustion chamber can be supplied to augment the exhaust flow to the exhaust turbine, especially when starting the engine and for boosting the turbo charger output during sudden loading such as by rapid acceleration. This type of anti-lag system adds significant complication to the turbo charger, as fuel, air, and an ignition source must all be connected to the combustion chamber, and each of these must have proper control systems working together.

Other approaches to mitigating turbo lag involve using a bypass to route air from the compressor side of the turbo charger to the exhaust side. This type of turbo charger reduces the amount of forced induction by the compressor. And this type of system still suffers from the underlying lag problem because it ultimately relies on exhaust gas to initiate turbo charging.

Such conventional methods and systems have generally been considered satisfactory for their intended purpose. However, there is still a need in the art for systems and methods that allow for improved turbo charger performance, and especially for improved turbo charger performance at low power levels, rapid acceleration, and the like. There also remains a need in the art for such methods and systems that are easy to make and use. The present invention provides a solution for these problems.

### SUMMARY OF THE INVENTION

The subject invention is directed to a new and useful turbo charger for an internal combustion engine. The turbo charger includes a turbo charger housing defining a spool axis and including an exhaust chamber having an exhaust inlet and an exhaust outlet. The turbo charger housing also defines an air compressor chamber having an air inlet and an air outlet. A spool is mounted within the turbo charger housing for rotation about the spool axis. The spool includes a spool shaft with an exhaust turbine wheel mounted at one end and an air compressor wheel coaxially mounted for common rotation at the opposite end of the spool shaft. The spool is configured and adapted to compress air passing from the air inlet through the air compressor chamber to the air outlet by rotating the compressor wheel with power from exhaust rotating the exhaust turbine wheel by passing from the exhaust inlet through the exhaust chamber to the exhaust outlet. A compressed gas injector is mounted to the exhaust chamber of the turbo charger housing for providing a compressed gas flow to the exhaust turbine wheel from a source external to the turbo charger housing in order to supplement power from the exhaust to rotate the spool.

In accordance with certain embodiments, the turbo charger further includes a compressed gas supply in fluid communication with the compressed gas injector for supplying compressed gas to the compressed gas injector. The compressed gas supply can include a pressure vessel configured to store compressed gas. It is also contemplated that the compressed gas supply can include a gas compressor configured to produce a supply of compressed gas to the compressed gas injector. The compressed gas injector can be configured and adapted to impinge compressed gas directly on the exhaust turbine wheel.

A turbo charger as described above can be included in an internal combustion engine having an engine block for converting internal combustion energy into power for turning a crank shaft. A combustion air supply system operatively connected to the engine block supplies combustion air for internal combustion within the engine block. An exhaust manifold operatively connected to the engine block conducts exhaust gases out of the engine block. The turbo charger can be operatively connected to the engine block for turbo charging internal combustion within the engine block. The exhaust inlet of the turbo charger can be connected in fluid communication with the exhaust manifold of the engine block. The air outlet of the turbo charger can be connected in fluid communication with the combustion air supply system.

The invention also provides a method of making, manufacturing, and/or retrofitting a turbo charger for improved turbo charging. The method includes forming a bore through a turbo charger housing wall in an exhaust chamber portion of a turbo charger housing, wherein the exhaust chamber is configured and adapted to house an exhaust turbine wheel of a turbo charger spool. The method also includes mounting a compressed gas injector to the bore for providing a compressed gas flow to an exhaust turbine wheel to supplement power from exhaust to rotate a turbo charger spool.

In accordance with certain embodiments, the method of retrofitting includes connecting a compressed gas supply in fluid communication with the compressed gas injector for supplying compressed gas to the compressed gas injector. A pressure vessel can be connected in fluid communication with the compressed gas injector for storing compressed gas. A gas compressor can be connected in fluid communication with the compressed gas injector to produce a supply of compressed gas to the compressed gas injector. Mounting the compressed gas injector can include positioning the compressed gas injector to impinge compressed gas directly on the exhaust turbine wheel.

The invention also provides a method of operating an internal combustion engine with a turbo charger. The method includes supplementing exhaust gas flow powering an exhaust turbine wheel of a turbo charger with a flow of auxiliary gas from a compressed gas source to increase turbo charger compressor output at a first level of engine revolutions per minute. Flow of auxiliary gas from the compressed gas source can be reduced in response to increased exhaust flow at a second level of engine revolutions per minute that is higher than the first level.

In certain embodiments, engine power at or above the second level of engine revolutions per minute can be used to charge a compressed gas supply for use as auxiliary gas for supplementing exhaust gas flow in the turbo charger. This can include, for example, using a gas compressor to pressurize a gas pressure vessel to store gas for use as the compressed gas supply. It is also contemplated that supplementing exhaust flow can include activating a gas compressor and supplying compressed gas through an air line from the air compressor directly to the exhaust turbine wheel, such that the compressed gas impinges directly on the exhaust turbine wheel.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a side elevation view of an exemplary embodiment of an internal combustion engine with a turbo charger constructed in accordance with the present invention, showing the connections for exhaust and air between the engine block and the turbo charger;

FIG. 2 is a schematic cut away perspective view of the turbo charger of FIG. 1, showing the spool with exhaust turbine wheel and compressor wheel mounted for common rotation within the turbo charger housing, indicating the flow of exhaust, air, and compressed gas;

FIG. 3 is a cross-sectional end elevation view of a portion of the turbo charger of FIG. 2, schematically showing the compressed gas injector impinging a flow of compressed gas directly onto the exhaust turbine wheel to supplement exhaust flow at low levels of engine revolutions per minute;

FIG. 4 is a schematic view of the internal combustion engine of FIG. 1, showing a pressure vessel connected in fluid communication to the compressed gas injector by way of a compressed gas line;

FIG. 5 is a schematic view of another exemplary embodiment of an internal combustion engine with a turbo charger constructed in accordance with the present invention, showing optional components for storing exhaust gas for use as the compressed gas for pre-spooling the turbo charger;

FIG. 6 is a graph showing data from an exemplary embodiment of a turbo charger pre-spooler constructed in accordance with the present invention, showing horse power, torque, and boost pressure each as a function of revolutions per minute (RPM's) with and without pre-spooling, wherein the pre-spooler was activated and deactivated before application of full throttle;

FIG. 7 is a graph showing data from the turbo charger pre-spooler of FIG. 6, showing horse power, torque, and boost pressure each as a function of RPM's with and without pre-spooling, wherein the pre-spooler was activated before application of full throttle and maintained continuously active throughout the run; and

FIG. 8 is a graph showing data from an exemplary embodiment of a turbo charger pre-spooler constructed in accordance with the present invention, showing horse power, torque, and boost pressure each as a function of RPM's with and without pre-spooling, wherein the pre-spooler was activated simultaneously with application of full throttle.

### DETAILED DESCRIPTION OF THE PREFERRED EMBODIMENTS

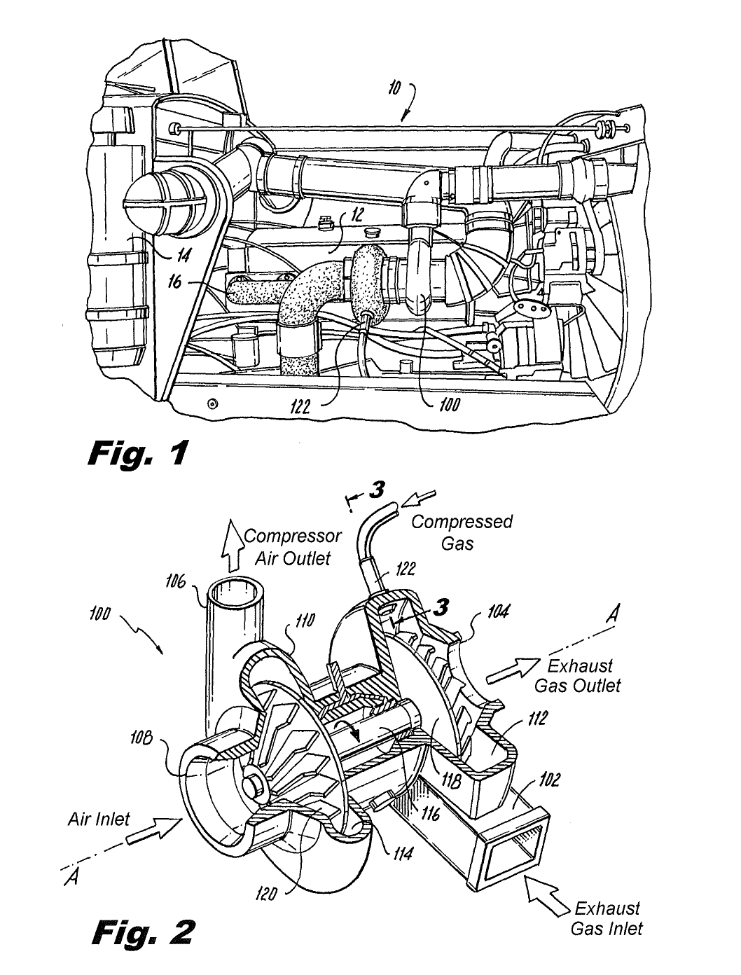

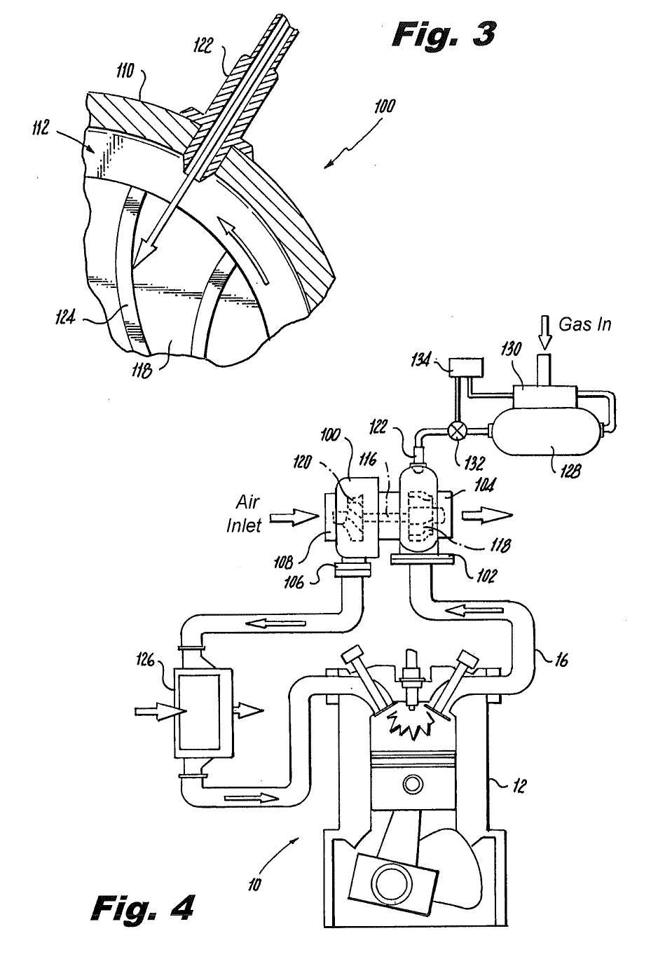

Reference will now be made to the drawings wherein like reference numerals identify similar structural features or aspects of the subject invention. For purposes of explanation and illustration, and not limitation, a partial view of an exemplary embodiment of a turbo charger in accordance with the invention is shown in FIG. 1 and is designated generally by reference character 100. Other embodiments of turbo chargers in accordance with the invention, or aspects thereof, are provided in FIGS. 2-8, as will be described. The systems of the invention can be used for improved turbo charger performance, especially for improved turbo charger performance at low power levels, rapid acceleration, and the like.

Referring now to FIG. 1, turbo charger 100 is shown mounted to an internal combustion engine 10 having an engine block 12 for converting internal combustion energy into power for turning a crank shaft. A combustion air supply system 14 is operatively connected to engine block 12 to supply combustion air for internal combustion within engine block 12. An exhaust manifold 16 is operatively connected to engine block 12 to conduct exhaust gases out of engine block 12. Turbo charger 100 is operatively connected to exhaust manifold 16 for turbo charging the internal combustion within engine block 12.

With reference now to FIG. 2, exhaust inlet 102 of turbo charger 100 is connected in fluid communication with exhaust manifold 16 of engine block 12. Exhaust outlet 104 is connected to an exhaust pipe for discharging the exhaust from engine 10. Compressor air outlet 106 feeds compressed air into engine block 12. Air inlet 108 of turbo charger 100 is connected in fluid communication to receive air from combustion air supply system 14.

With continued reference to FIG. 2, turbo charger 100 includes a turbo charger housing 110 defining a spool axis A and including an exhaust chamber 112 having exhaust inlet 102 and exhaust outlet 104. Turbo charger housing 110 also defines an air compressor chamber 114 which includes air inlet 108 and air outlet 106. A spool 116 is mounted within turbo charger housing 110 for rotation about spool axis A. Spool 116 includes a spool shaft with an exhaust turbine wheel 118 mounted at one end and an air compressor wheel 120 coaxially mounted for common rotation at the opposite end of the spool shaft. Spool 116 is configured and adapted to compress air passing from air inlet 108 through air compressor chamber 114 to compressor air outlet 106 by rotating compressor wheel 120 with power from exhaust rotating exhaust turbine wheel 118. Exhaust rotates exhaust turbine wheel 118 by passing from the exhaust inlet 102 through exhaust chamber 112 to exhaust outlet 104. A compressed gas injector 122 is mounted to the wall of exhaust chamber 112 of turbo charger housing 110 for providing a compressed gas flow to exhaust turbine wheel 118 from a source external to turbo charger housing 110 in order to supplement power from the exhaust to rotate spool 116.

Referring now to FIG. 3, the operation of compressed gas injector 122 is shown schematically. The small arrow schematically indicates exhaust flow when the power level of engine 10 is low, such as when operating at low revolutions per minute. The large arrow schematically indicates a flow of compressed gas issuing from compressed gas injector 122, impinging directly on turbine blades 124 of exhaust turbine wheel 118. This compressed gas flow supplements the relatively weak exhaust flow, driving spool 116 and thereby supercharging engine 10 even when the exhaust flow is inadequate to do so on its own, such as at low power operation, e.g., when engine revolutions per minute are at a low level. This also remedies turbo lag such as during rapid acceleration, or the like. Therefore, compressed gas injector 122 is a pre-spooler, i.e., it spools up exhaust turbine wheel 118 in advance of the exhaust gas itself.

With reference now to FIG. 4, a compressed gas supply is included in fluid communication with compressed gas injector 122 for supplying compressed gas to compressed gas injector 122. FIG. 4 shows the connections between engine block 12 and turbo charger 100 schematically. Air from inlet 108 is compressed and issued from air outlet 106 as described above, and through an optional charged air cooler 126 to release heat from the compressed air, as indicated by the arrows into and out of charged air cooler 126 in FIG. 4, and thereby increase the force induction volumetric flow to engine block 12. The pistons of engine block 12 produce increased power under the forced induction, and the combustion products are exhausted to exhaust manifold 16. As described above, exhaust manifold 16 supplies a flow of exhaust gas to exhaust inlet 102 of turbo charger 100, which turns exhaust turbine wheel 118 and is exhausted through exhaust outlet 104. Compressed gas injector 122 provides auxiliary power to exhaust turbine wheel 118 as described above, using compressed gas from a compressed gas supply. The compressed gas supply includes a pressure vessel 128 configured to store compressed gas, wherein the compressed gas is air, for example. The compressed gas supply can also include an auxiliary air compressor 130 configured to produce a supply of compressed air to compressed gas injector 122. As indicated schematically in FIG. 4, auxiliary air compressor 130 is connected in fluid communication to pressurize pressure vessel 128 using low pressure air, e.g., atmospheric air.

Those skilled in the art will readily appreciate that it is optional to have both an auxiliary compressor and an a pressure vessel. For example, it is contemplated that turbo charger 100 can be operated solely with an auxiliary compressor that feeds compressed gas directly to compressed gas injector 122 without a storage tank. It is also contemplated that a pressure vessel can be used without an on board auxiliary compressor, wherein the pressure vessel is periodically charged from an external pressure source. For systems with onboard air compression, for example semi-tractor trailer trucks, the main air compression system can be connected to compressed gas injector 122. It is contemplated that any suitable gas can be used for injection through compressed gas injector 122, such as compressed air. It is also contemplated that exhaust can be compressed and used for injection through compressed gas injector 122, for example, by bypassing some of the exhaust from exhaust manifold 16 through compressor 130. For embodiments with an auxiliary compressor, it is contemplated that the auxiliary compressor can be powered directly from the engine, such as by belts, chains, or gears, or by any other suitable source, such as battery power.

Injector 122 can be configured on an application by application basis. More than one injector can be used as needed in a given application. Injector size/diameter, placement, quantity, depth into the exhaust housing, angle, pressure, time of inception, type of gas and duration can all be determined based on engine displacement/cylinder head flow and turbo charger wheel/housing variations. Injector 122 can be optimized to specific needs/variables to achieve optimum spool/efficiency for specific engine/turbo packages. It is also optional whether to manufacture injector 122 as one piece, e.g., cast, within the exhaust housing or to retrofit premanufactured exhaust housings with an injector 122.

With continued reference to FIG. 4, a method of operating an internal combustion engine 10 with turbo charger 100 is described. The method includes supplementing exhaust gas flow powering an exhaust turbine wheel of a turbo charger, e.g., turbo charger 100, with a flow of auxiliary gas from a compressed gas source to increase turbo charger compressor output at a first level of engine revolutions per minute. Flow of auxiliary gas from the compressed gas source can be reduced in response to increased exhaust flow at a second level of engine revolutions per minute that is higher than the first level. Flow from compressed gas injector 122 can be increased and decreased using valve 132 in the line between the compressed gas source and compressed gas injector 122. Valve 132 can in turn be controlled as needed to increase and decrease flow from compressed gas injector 122 using a control system, such as an engine control unit (ECU) 134. For example, ECU 134 can be programmed to increase flow through compressed gas injector 122 in response to low revolutions per minute, e.g., idling, and/or rapid increase in accelerator input. ECU 134 can also be programmed to decrease flow through compressed gas injector 122 in response to high revolutions per minute, e.g., higher than idle such as cruising, and/or steady accelerator input.

For embodiments where an auxiliary compressor is included, e.g., compressor 130, ECU 134 can also control operation of the compressor. For example, when engine power is at or above the second level of engine revolutions per minute, ECU 134 can activate compressor 130 to charge pressure vessel 128. ECU 134 can deactivate compressor 130 when engine power drops below a given level, or when pressure vessel 128 is full.

The invention also provides a method of retrofitting a turbo charger for improved turbo charging. The method includes forming a bore through a turbo charger housing wall in an exhaust chamber portion of a turbo charger housing, wherein the exhaust chamber is configured and adapted to house an exhaust turbine wheel of a turbo charger spool. The method also includes mounting a compressed gas injector, e.g., compressed gas injector 122, to the bore for providing a compressed gas flow to an exhaust turbine wheel to supplement power from exhaust to rotate a turbo charger spool, as shown in FIG. 3, for example. Mounting the compressed gas injector includes positioning the compressed gas injector in a position allowing it to impinge compressed gas directly on the exhaust turbine wheel. Such a retrofit can also include connecting a pressure vessel and/or auxiliary compressor to the compressed gas injector 122, as well as connecting a control system such as ECU 134 to operate the retrofitted turbo charger.

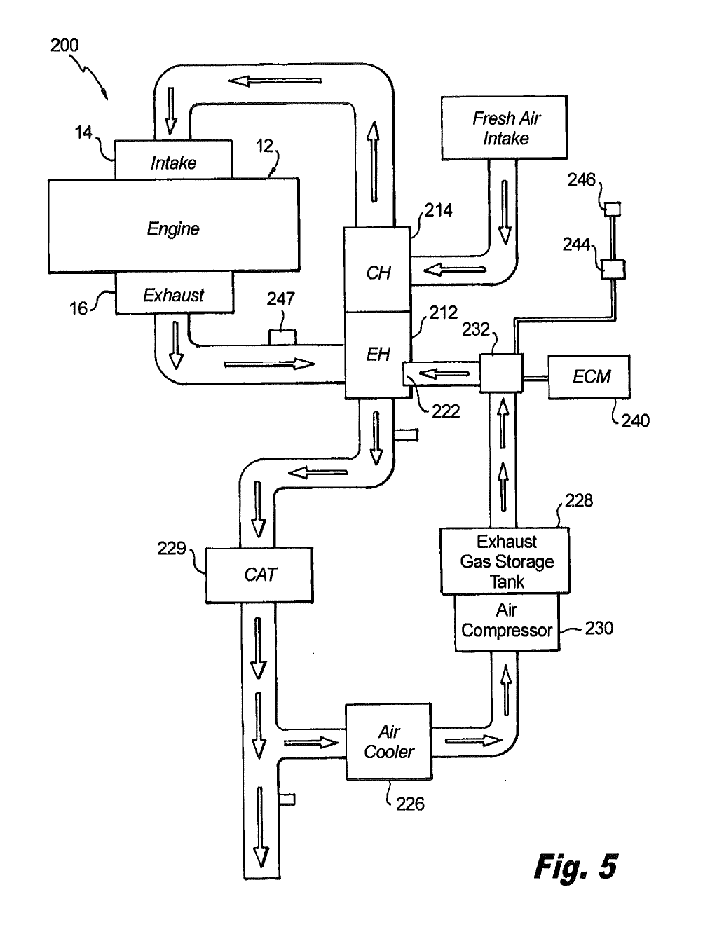

With reference now to FIG. 5, depending on application and emissions requirements, exhaust gas downstream of an optional catalytic converter in an exhaust pipe can be redirected to a compressor and/or storage tank for use in turbo charger pre-spooling as described above. In FIG. 5, system 200 includes engine block 12 with air supply system 14, exhaust manifold 16, and a turbo charger with an exhaust chamber 212 and air compressor chamber 214 substantially as described above. Exhaust gas passing from exhaust chamber 212 passes through a catalytic converter 229 for eventual discharge from a tail pipe, exhaust stack, or the like. A conduit connects the exhaust line downstream of catalytic converter 229 through an optional gas discharge cooler 226 to gas compressor 230. Some or all of the exhaust gas can be diverted through cooler 226 by compressor 230 as needed to charge pressure vessel 228 with pressurized exhaust gas. Gas charger cooler 226 is used to cool exhaust gas passing therethrough if the temperature of catalytic converter 229 is high during activation of compressor 230. A solenoid valve 232 is included in the gas line from pressure vessel 228 to injector 222 in exhaust chamber 212. Solenoid valve 232 is controlled by engine control module 240, relay 244, and fuse 246 to supply compressed exhaust gas to injector 222 as needed for driving the turbo charger. Those skilled in the art will readily appreciate that the control configuration with engine control module 240, relay 244, and fuse 246 is optional, and that any other suitable control configuration can be used without departing from the spirit and scope of the invention.

While using exhaust gas as the pressurized pre-spooling gas is optional, it is advantageous because exhaust gas is essentially inert after passing through a catalytic converter and will not affect the readings of optional front oxygen sensor 247 for proper fuel management and emissions. Such systems can be made compliant with on-board diagnostics standards such as OBD-II and vehicle bus standards such as CAN bus. For engines without oxygen sensor feedback for fuel management, for example, older diesel truck engines with mechanical fuel injection, compressed oxygen “air” is also acceptable for use as a pre-spooler compressed gas.

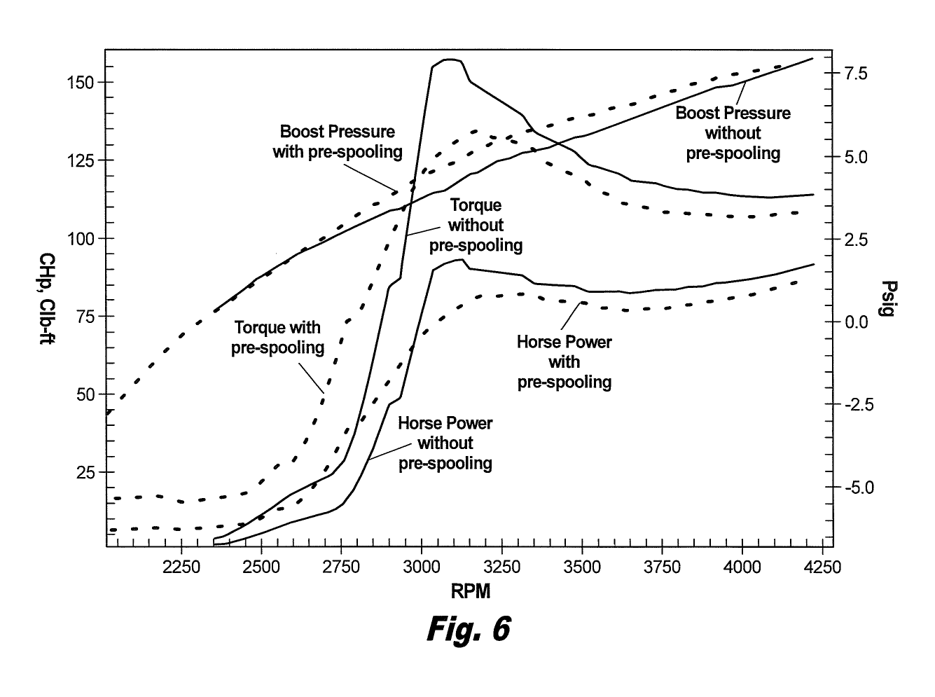

With reference now to FIGS. 6-8, performance data is shown for an example of a pre-spooler as described above. In FIG. 6, a turbocharged automobile equipped with a pre-spooler, as described above, was monitored on a chassis dynamometer. The data in FIG. 6 includes data for one dynamometer run without using the pre-spooler, and one dynamometer run in which the pre-spooler was activated. In both runs, the test started with a slow, idling roll of approximately ¼ mph, followed by a full throttle burst. In the case using the pre-spooler, the pre-spooler was briefly activated, then deactivated before the full throttle was applied. The graph in FIG. 6 includes three pairs of data sets. First, the boost pressure is plotted as a function of RPM's for the run without the pre-spooler, and for the run with the pre-spooling, with the gauge pressure scale on the right axis. Second, the torque data are plotted for each run, with and without pre-spooling, with the torque scale on the left axis. Third, the horse power data are plotted for each run, with and without pre-spooling, with the horse power also along the left axis. The torque and horse power both increased sooner for the pre-spooler run, for example, horse power increased about 125 RPM's sooner for the pre-spooler run than for the run without pre-spooling. Also, the boost pressure during the pre-spooling run was equal to or greater than the boost pressure during the run without pre-spooling.

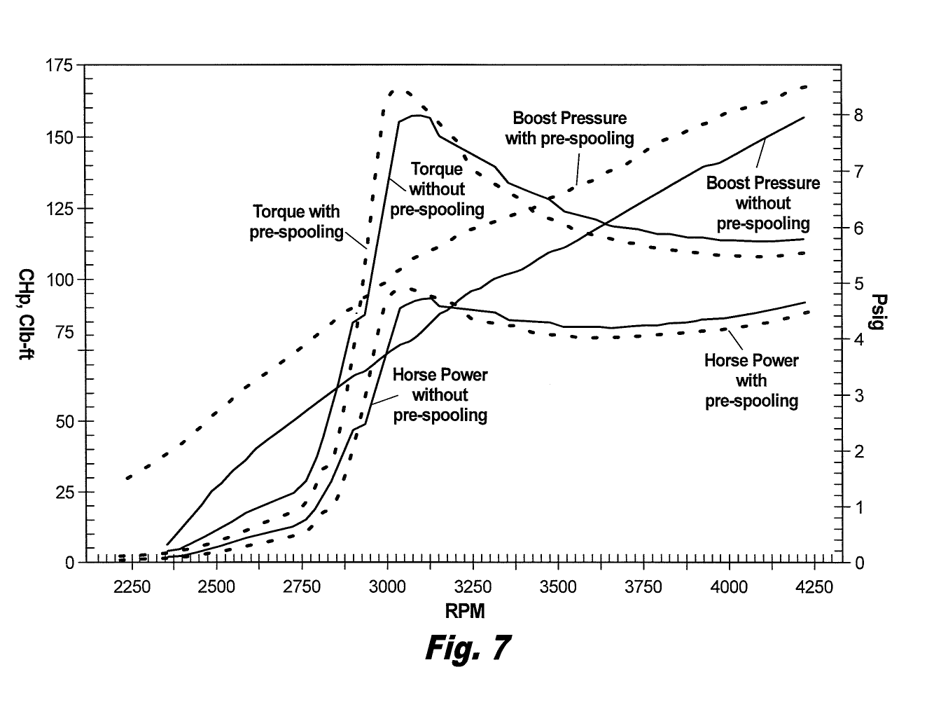

Referring now to FIG. 7, two more runs were conducted with the same equipment and basic set up as that described above with reference to FIG. 6, except that during the pre-spooling run the pre-spooler was activated before the full throttle was applied, and the pre-spooler remained activated continuously throughout the run. The data in FIG. 7 show that boost pressure was higher throughout the run with pre-spooling than for the run without pre-spooling, and the peak torque and horsepower were reached sooner with pre-spooling than without.

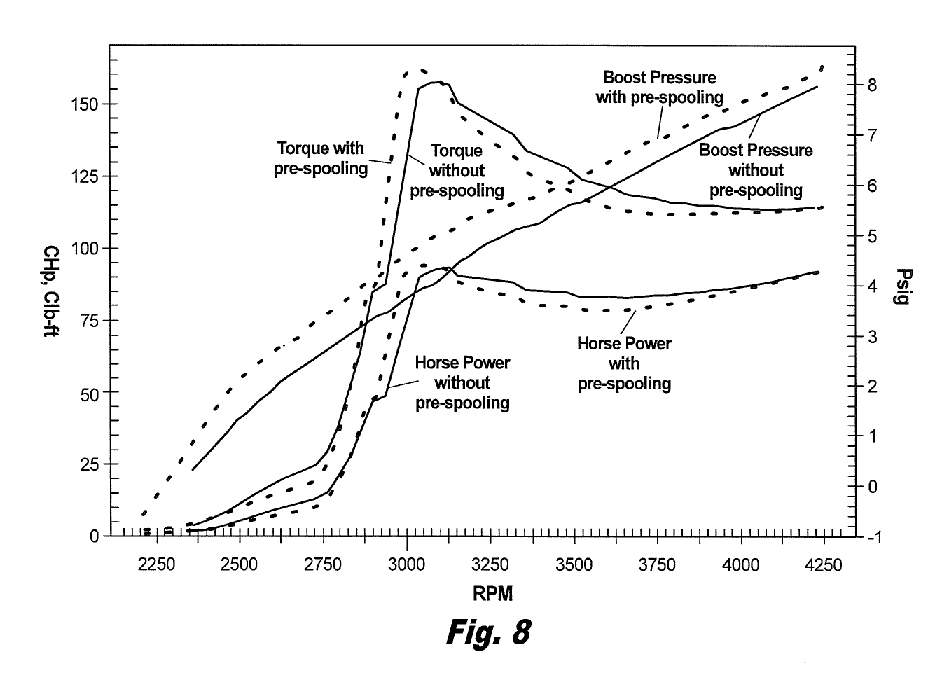

With reference now to FIG. 8, two more runs were conducted with the same equipment and basic set up as described above with reference to FIGS. 6 and 7, except that during the pre-spooling run, the activation of the pre-spooler and the application of full throttle occurred simultaneously and the pre-spooler remained active throughout the run. The results in FIG. 8 are similar to those in FIG. 7 above, namely boost pressure was higher throughout the run with pre-spooling than for the run without pre-spooling, and the peak torque and horsepower were reached sooner with pre-spooling than without. The data shown in FIGS. 6-8 demonstrate the benefits of pre-spooling as described herein, with a particular increase in turbo boost during sudden acceleration.

The devices and methods described herein have various applications. One example is a mainstream application in which the enhanced turbo charging decreases engine displacement and increases turbo size while still maintaining the same horsepower/torque ratings. In such applications the start off acceleration, idle and cruise fuel consumption is be greatly reduced. Smaller engines reduce production costs and emissions. Smaller engines also reduce weight which further increase fuel mileage. Another exemplary application is in racing. In racing applications, enhanced turbo charging as described herein can be used to improve off the line and initial throttle response/power at low engine RPM's, for example. Another benefit of the systems and methods described above is that in operation at low engine RPM's they provide for lowered exhaust manifold pressure than in traditional turbo chargers, which aids in exhaust/cylinder scavenging, which can increase engine low end torque and efficiency.

While it has been shown and described above in the exemplary context of a diesel engine for at semi-tractor trailer truck, those skilled in the art will readily appreciate that any other suitable engine type and vehicle type can be used without departing from the spirit and scope of the invention. For example, it is contemplated that two-stroke engines or four-stroke engines can be used. Engines using any suitable fuel can be used, such as diesel, gasoline, or the like. Moreover, any suitable vehicle type or equipment with an internal combustion engine fitted with a turbo charger can be used, such as trucks, passenger cars, aircraft, muscle cars, sports cars, race cars, and the like without departing from the spirit and scope of the invention.

The methods and systems of the present invention, as described above and shown in the drawings, provide for turbo chargers with superior properties including improved turbo charger performance at low power levels, rapid acceleration, and the like. While the apparatus and methods of the subject invention have been shown and described with reference to preferred embodiments, those skilled in the art will readily appreciate that changes and/or modifications may be made thereto without departing from the spirit and scope of the subject invention.

What is claimed is:

1. A turbo charger for an internal combustion engine comprising:
a turbo charger housing defining a spool axis and including an exhaust chamber having an exhaust inlet and an exhaust outlet, the turbo charger housing also defining an air compressor chamber having an air inlet and an air outlet;
a spool mounted within the turbo charger housing for rotation about the spool axis, the spool including a spool shaft with an exhaust turbine wheel mounted at one end and an air compressor wheel coaxially mounted for common rotation at an end of the spool shaft opposite the exhaust turbine wheel, wherein the spool is configured and adapted to compress air passing from the air inlet through the air compressor chamber to the air outlet by rotating the compressor wheel with power from exhaust rotating the exhaust turbine wheel by passing from the exhaust inlet through the exhaust chamber to the exhaust outlet; and
a compressed gas injector mounted to the exhaust chamber of the turbo charger housing for providing a compressed gas flow to the exhaust turbine wheel from a source external to the turbo charger housing in order to supplement power from the exhaust to rotate the spool.

2. A turbo charger as recited in claim 1, further comprising a compressed gas supply in fluid communication with the compressed gas injector for supplying compressed gas to the compressed gas injector.

3. A turbo charger as recited in claim 2, wherein the compressed gas supply includes a pressure vessel configured to store compressed gas.

4. A turbo charger as recited in claim 2, wherein the compressed gas supply includes an air compressor configured to produce a supply of compressed air to the compressed gas injector.

5. A turbo charger as recited in claim 1, wherein the compressed gas injector is configured and adapted to impinge compressed gas directly on the exhaust turbine wheel.

6. An internal combustion engine comprising:
an engine block for converting internal combustion energy into power for turning a crank shaft;
a combustion air supply system operatively connected to the engine block for supplying combustion air for internal combustion within the engine block;
an exhaust manifold operatively connected to the engine block for conducting exhaust gases out of the engine block; and
a turbo charger operatively connected to the engine block for turbo charging internal combustion within the engine block, the turbo charger including:
a turbo charger housing defining a spool axis and including an exhaust chamber having an exhaust outlet and an exhaust inlet in fluid communication with the exhaust manifold, the turbo charger housing also defining an air compressor chamber having an air inlet and an air outlet in fluid communication with the combustion air supply system;
a spool mounted within the turbo charger housing for rotation about the spool axis, the spool including a spool shaft with an exhaust turbine wheel mounted at one end and an air compressor wheel coaxially mounted for common rotation at an end of the spool shaft opposite the exhaust turbine wheel, wherein the spool is configured and adapted to compress air passing from the air inlet through the air compressor chamber to the air outlet by rotating the compressor wheel with power from exhaust rotating the exhaust turbine wheel by passing from the exhaust inlet through the exhaust chamber to the exhaust outlet; and
a compressed gas injector mounted to the exhaust chamber of the turbo charger housing for providing a compressed gas flow to the exhaust turbine wheel from a source external to the turbo charger housing in order to supplement power from the exhaust to rotate the spool.

7. An internal combustion engine as recited in claim 6, further comprising a compressed gas supply in fluid communication with the compressed gas injector for supplying compressed gas to the compressed gas injector.

8. An internal combustion engine as recited in claim 7, wherein the compressed gas supply includes a pressure vessel operatively connected to the engine block for storing compressed gas.

9. An internal combustion engine as recited in claim 7, wherein the compressed gas supply includes an air compressor operatively connected to the engine block to produce a supply of compressed air to the compressed gas injector.

10. An internal combustion engine as recited in claim 6, wherein the compressed gas injector is configured and adapted to impinge compressed gas directly on the exhaust turbine wheel.

11. A method of making a turbo charger for improved turbo charging comprising:
forming a bore through a turbo charger housing wall in an exhaust chamber portion of a turbo charger housing, wherein the exhaust chamber is configured and adapted to house an exhaust turbine wheel of a turbo charger spool; and
mounting a compressed gas injector to the bore for providing a compressed gas flow to an exhaust turbine wheel to supplement power from exhaust to rotate a turbo charger spool.

12. A method as recited in claim 11, further comprising connecting a compressed gas supply in fluid communication with the compressed gas injector for supplying compressed gas to the compressed gas injector.

13. A method as recited in claim 12, wherein connecting a compressed gas supply includes connecting a pressure vessel in fluid communication with the compressed gas injector for storing compressed gas.

14. A method as recited in claim 12, wherein connecting a compressed gas supply includes connecting an air compressor in fluid communication with the compressed gas injector to produce a supply of compressed gas to the compressed gas injector.

15. A method as recited in claim 11, wherein mounting the compressed gas injector includes positioning the compressed gas injector to impinge compressed gas directly on the exhaust turbine wheel.

16. A method of operating an internal combustion engine with a turbo charger comprising:
supplementing exhaust gas flow powering an exhaust turbine wheel of a turbo charger with a flow of auxiliary gas from a compressed gas source to increase turbo charger compressor output at a first level of engine revolutions per minute.

17. A method as recited in claim 16, further comprising reducing flow of auxiliary gas from the compressed gas source in response to increased exhaust flow at a second level of engine revolutions per minute that is higher than the first level.

18. A method as recited in claim 17, further comprising using engine power at or above the second level of engine revolutions per minute to charge a compressed gas supply for use as auxiliary gas for supplementing exhaust gas flow in the turbo charger.

19. A method as recited in claim 18, wherein using engine power at or above the second level of engine revolutions per minute to charge a compressed gas supply includes using an air compressor to pressurize an air pressure vessel to store gas for use as the compressed gas supply.

20. A method as recited in claim 16, wherein supplementing exhaust flow includes activating an air compressor and supplying compressed gas through a gas line from the air compressor directly to the exhaust turbine wheel, such that the compressed gas impinges directly on the exhaust turbine wheel.
